(19) United States
(12) Patent Application Publication
(10) Pub. No.: US 2021/0394662 A1
(43) Pub. Date: Dec. 23, 2021

(54) INTELLIGENT TRANSFER VEHICLE FOR SHARED BICYCLES

(71) Applicant: BEIJING INSTITUTE OF TECHNOLOGY, Beijing (CN)

(72) Inventors: Fang DENG, Beijing (CN); Xiang SHI, Beijing (CN); Wenjie CHEN, Beijing (CN); Xiaobo WU, Beijing (CN); Xinyu FAN, Beijing (CN); Lele ZHANG, Beijing (CN); Li LIANG, Beijing (CN); Xin GAO, Beijing (CN); Xianghu YUE, Beijing (CN); Ziman YE, Beijing (CN); Feng GAO, Beijing (CN)

(21) Appl. No.: 17/334,366

(22) Filed: May 28, 2021

Related U.S. Application Data
(63) Continuation of application No. PCT/CN2019/000169, filed on Aug. 27, 2019.

(30) Foreign Application Priority Data
Nov. 28, 2018 (CN) 201811435238.1

(51) Int. Cl. B60P 3/07; B62H 3/00; B60W 60/00; B60W 40/12; B60W 40/06; B60W 50/14; G06Q 50/30; G06Q 10/06; G07C 5/08; G05B 13/02; G01C 21/34; G08B 7/06

(52) U.S. Cl. CPC B60P 3/07; B62H 3/00; B60W 60/00253; B60W 60/005; B60W 40/12; B60W 40/06; B60W 2050/143; G06Q 50/30; G06Q 10/06315; G07C 5/0808; G05B 13/028; G01C 21/3423; G08B 7/06; B60W 50/14

(57) ABSTRACT

An intelligent transfer vehicle for shared bicycles includes: a cockpit, a vehicle body platform, shared bicycle parking racks, a wheeled device, a power source unit, and a vehicle-mounted unit. The intelligent transfer vehicle combines the function of a parking platform and a transfer platform into one, and can have three transfer modes to reduce reliance on a dispatch center, save costs and improve transfer efficiency.

### FIELD

The present disclosure relates to a transfer vehicle, in particular to an intelligent transfer vehicle for shared bicycles, and belongs to the technical field of intelligent vehicles.

### BACKGROUND

The emergence of shared bicycles has brought great convenience to people's travel. With the increasing popularity of shared bicycles, more and more people use them for travel. However, with the number of shared bicycles increases and the variance in people's usage at different periods, the shared bicycle system has problems of uneven distribution in time and space, such as the “tidal phenomenon”. For example, in some areas, there is a shortage of shared bicycles, while in other areas there are a large number of idling shared bicycles. In order to solve this problem, dispatching and transferring of shared bicycles is very necessary.

In the current market, many companies, including Mobike, ofo, etc., mainly rely on manual handling and driving transport vehicles for the dispatch of shared bicycles. However, this method has the following disadvantages:

1. This method requires the transfer personnel to constantly move and load a large number of shared bicycles, which consumes a lot of manpower and increases the operating costs.

2. The transfer method has the characteristics of wide transfer distance and long cycle. Due to cost constraints, the number of existing transport vehicles and transfer personnel cannot meet the transshipment needs of various regions in time.

3. At present, the transfer vehicle used in this method has a large capacity and high cost, so it is not suitable for small-scale vehicle transfer, and will cause waste of resources and increased operating costs.

### SUMMARY

In view of this, the present invention provides an intelligent transfer vehicle for shared bicycles that combines a parking platform and a transfer platform into one, which can effectively solve the problem that traditional transfer scheduling requires a large amount of manpower to transport the shared bicycles.

The intelligent transfer vehicle for shared bicycles includes: a cockpit, a vehicle body platform, a plurality of shared bicycle parking racks, wheeled device, power source unit, and vehicle-mounted unit.

The vehicle-mounted unit is provided in the cockpit, and the intelligent transfer vehicle is provided with the functions of man-driven and unmanned autonomous travel through the vehicle-mounted unit.

The wheeled device is used as a driving device and is located at the bottom of the vehicle body platform.

Two or more shared bicycle parking racks are provided on the vehicle body platform. The vehicle body platform is used as a parking platform when the intelligent transfer vehicle is parked, and users can park or take a shared bicycle thereon. During the traveling process of the intelligent transfer vehicle, the vehicle body platform is used as a transfer platform for the transfer of shared bicycles.

The power source unit is used to provide energy and power for the entire intelligent transfer vehicle.

The intelligent transfer vehicle for shared bicycles has three transfer modes, which are a man-driven transfer mode, an unmanned autonomous transfer mode, and a human-vehicle hybrid transfer mode.

The man-driven transfer mode is: the intelligent transfer vehicle is manually operated by the driver according to the task requirements.

The unmanned autonomously transfer mode is: the intelligent transfer vehicle starts at a preset start time and travels autonomously according to a planned route, which is completed by the vehicle-mounted unit according to a preset destination.

The human-vehicle hybrid transfer mode is: the intelligent transfer vehicle travels autonomously according to control instructions issued by dispatch center received by the vehicle-mounted unit.

As a preferred mode of the present invention, a landing board is provided at the end of the vehicle body platform. When the transfer vehicle is parked, the landing board stretches obliquely downward and connects with the ground to form a connection channel between the ground and the vehicle body platform. At this time, the intelligent transfer vehicle is used as a parking platform; before the intelligent transfer vehicle is started, the landing board is retracted and limited to a position that does not contact the ground, so that the intelligent transfer vehicle can travel normally.

### Beneficial Effects

(1) The intelligent transfer vehicle for shared bicycle provided by the present invention employs a combination mode for the parking rack and vehicle body platform, that is, a parking platform and a transfer platform are combined into one. This combination mode is not only convenient for users to park and take bicycles, but also avoids manual transportation of vehicles during the transfer process, which saves resources and reduces operating costs.

(2) The transfer mode provided by the intelligent transfer vehicle includes three modes: man-driven transfer mode, unmanned autonomous transfer mode, and human-vehicle hybrid transfer mode. Among them, most of the daily transfer tasks can be completed automatically by the unmanned autonomous transfer mode, which greatly reduces the amount of dispatch tasks for the operator. The man-driven or human-vehicle hybrid transfer mode can not only complete the above daily dispatch tasks, but also can cooperate with intervention or alarm modes (described below) in special situations to enable the dispatch center to understand and control the behavior of the intelligent transfer vehicle, which ensures the safety of the vehicle traveling.

(3) The intelligent transfer vehicle is designed to be small in size and flexible in operation, which can not only meet and reduce the multi-region large-scale transfer demand during the peak period of transfer, but also be used for the transfer of small-scale shared bicycles. At the same time, users are encouraged to park shared bicycles on transfer vehicles through a reward mechanism to reduce random parking.

### BRIEF DESCRIPTION OF THE DRAWINGS

FIG. 1 is the overall structure of the intelligent transfer vehicle for shared bicycle.

FIG. 2 is a block diagram of the vehicle-mounted unit system module of the intelligent transfer vehicle for shared bicycle.

FIG. 3 is a flowchart of dispatch tasks performed by the intelligent transfer vehicle for shared bicycle.

Wherein: 1—cockpit, 2—vehicle body platform, 3—shared bicycle parking rack, 4—wheeled device, 5—power source unit, 6—vehicle-mounted unit.

### DETAILED DESCRIPTION OF THE EMBODIMENTS

Preferred implementation of the present disclosure is described in detail below.

### Embodiment 1

This embodiment provides an intelligent transfer vehicle for shared bicycles, which can effectively solve the problem that traditional transfer scheduling requires a large amount of manpower and has low intelligence.

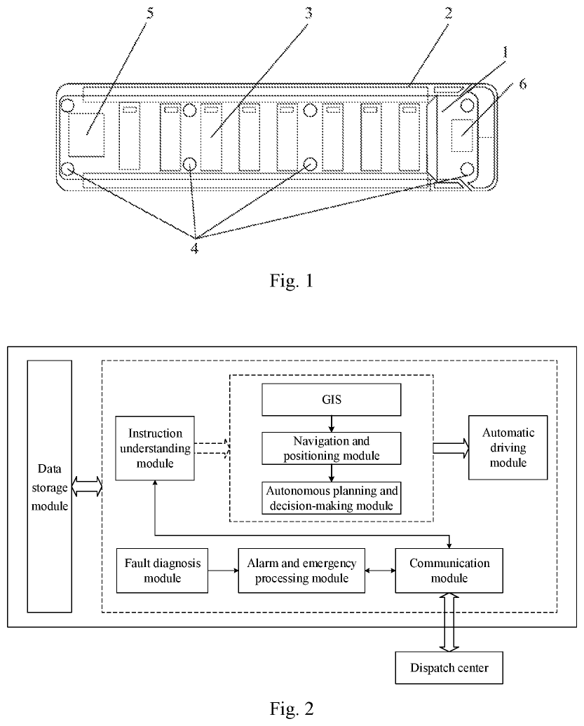

As shown in FIG. 1, the intelligent transfer vehicle for shared bicycle includes cockpit 1, vehicle body platform 2, shared bicycle parking rack 3, wheeled device 4, power source unit 5 and vehicle-mounted unit 6.

Vehicle-mounted unit 6 is provided in cockpit 1 on the basis of the cockpit of a traditional vehicle, so that it can meet the functions of man-driven driving and unmanned autonomous travel at the same time. The top of the cockpit 1 is provided with a warning light device, which is used to issue a reminder in conjunction with a warning voice when the intelligent transfer vehicle starts and stops.

As a driving device, the wheeled device 4 is located at the bottom of the vehicle body platform 2. The wheeled device 4 includes a plurality of wheels which are symmetrically arranged at the bottom of the vehicle body platform 2 (left and right). The vehicle body platform 2 is also used as a platform for parking shared bicycles, that is, a plurality of shared bicycle parking racks 3 are provided above the vehicle body platform 2 to facilitate users to park/take shared bicycles. Shared bicycle parking racks 3 have simple slot type and are fixed side by side on the vehicle body platform 2. Each shared bicycle parking rack 3 is equipped with a detection sensor (such as a pressure sensor) for detecting whether there is a shared bicycle parked. In order to facilitate the user to park/take the shared bicycles, the wheeled device 4 is designed to be retractable. When the intelligent transfer vehicle is parked, the wheels are contracted into the vehicle body platform 2 so that the vehicle body platform 2 lies on the ground. At this time, the intelligent transfer vehicle is used as a parking platform; before the intelligent transfer vehicle starts, the wheels are extended to enable the intelligent transfer vehicle to travel.

The power source unit 5 is used to provide energy and power for the entire intelligent transfer vehicle. It can use multiple energy supply methods, such as oil, gas, electricity or new energy and so on.

The vehicle-mounted unit 6 is a core component of the intelligent transfer vehicle and placed inside the cockpit 1. As shown in FIG. 2, the vehicle-mounted unit includes a data storage module, an instruction understanding module, a path planning module, an automatic driving module, a fault diagnosis module, an alarm and emergency processing module, and a communication module. The path planning module includes a GIS (Geographic Information System) module, navigation and positioning module, and autonomous planning and decision-making module.

The data storage module is connected with the other modules in the vehicle-mounted unit for data interaction and stores the received data information. The instruction understanding module and the communication module are connected and interact to complete the analysis of the received instructions from the dispatch center, and then the parsed information will be sent to the path planning module according to the pre-stored analysis instruction set. The instruction understanding module pre-stores multiple commonly used instruction sets, so that the intelligent transfer vehicle can quickly and accurately execute the transfer instructions issued by the dispatch center.

In the unmanned autonomous mode, the path planning of the intelligent transfer vehicle is coordinated by the GIS module, navigation and positioning module and autonomous planning decision module in the path planning module. The planned path will be sent to the autonomous driving module. The specific process is as follows: a high-precision map is pre-stored in the GIS module, and the autonomous planning decision module performs path planning based on the high-precision map, the current location information provided by the navigation and positioning module, and the destination location information provided by the dispatch center. The optimal route to the destination is obtained based on shortest time.

After the automatic driving module receives the optimal path sent by the path planning module, the intelligent transfer vehicle travels autonomously. In this process, the road information around the position of the intelligent transfer vehicle can be sensed in real-time by sensors installed on the vehicle body platform. The sensors include vision sensors (image acquisition devices, etc.), laser sensors, etc. The automatic driving module and the navigation and positioning module have the ability to identify road conditions, control vehicle speed and direction and obstacle avoidance, so the autonomous driving tasks can be completed safely and reliably.

The fault diagnosis module can obtain the running status data (speed, temperature, pressure) of each key component of the intelligent transfer vehicle in real-time from the data storage module. This module can realize real-time monitoring of the running status of the intelligent transfer vehicle and diagnose and predict possible faults through process monitoring and fault prediction and diagnosis algorithms. Once a component is found faulty or is about to fail, fault information will be timely sent to the dispatch center by the fault diagnosis module through the communication module for follow-up processing.

The alarm and emergency processing module includes a voice device, an alarm device and an emergency stop device, wherein the voice device is used to transmit voice and light warnings in conjunction with the alarm light device on the top of the cockpit when the intelligent transfer vehicle starts and stops; the alarm device is used to send an alarm to the dispatch center through the communication module when an unexpected situation such as a collision or damage occurs in the transfer vehicle; the emergency stop device is used to suspend the current operation of the transfer vehicle for emergency processing.

The communication module is connected to the alarm and emergency processing module and the instruction understanding module, respectively, and is used to transfer information between the dispatch center and the intelligent transfer vehicle.

There are five modes of the intelligent transfer vehicle for shared bicycles: parking mode, transfer mode, start-up mode, intervention mode and alarm mode. In the parking mode, the vehicle body platform can be used as a platform for parking and taking shared bicycles when the intelligent transfer vehicle is stationary, which is convenient for users to park/take shared vehicles. The parking mode also has the function of counting the number of parking vehicles. In the transfer mode, the intelligent transfer vehicle can complete the dispatch tasks through three modes: man-driven transfer, unmanned autonomous transfer, and human-vehicle hybrid transfer mode. In the start-up mode, the intelligent transfer vehicle perform various preparation operations before the vehicle starts. The intervention mode refers to when the intelligent transfer vehicle encounters an unexpected situation such as changing the current driving route, it can be manually commanded and taken over. The alarm mode means that when the intelligent transfer vehicle encounters an emergency situation or is damaged by forced movement, it can stop the current operation and send an alarm message to the dispatch center for follow-up processing.

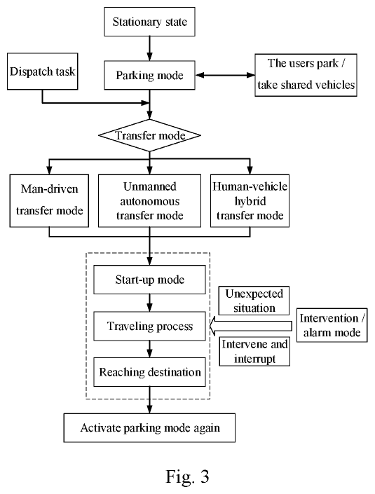

The flow of the intelligent transfer vehicle for shared bicycle when performing dispatch tasks is shown in FIG. 3:

When the intelligent transfer vehicle is in the parking mode: the wheels are contracted into the vehicle body platform so that the vehicle body platform lies on the ground. At this time, the intelligent transfer vehicle is used as parking racks for users to park/take shared bicycles. When the shared bicycle is parked on the parking rack by the user, the detection sensor on the parking rack senses it and sends a bicycle storage signal to the data storage module. The data storage module sends the bicycle storage signal to the dispatch center through the communication module. The dispatch center locates the intelligent transfer vehicle for shared bicycles according to the navigation and positioning module. After confirming that the corresponding shared bicycle does not exceed the permitted parking area, the parking user will be given certain points through the back-end server as a standard parking reward. At the same time, the data storage module records the number of shared bicycles carried by the current intelligent transfer vehicle in real-time, and then transmits the recorded number of shared bicycles to the dispatch center through the communication module, so that the dispatch center can understand the number of distribution of shared bicycles in each area.

When dispatching demand arises, the dispatch center issues dispatching instructions based on the number of shared bicycles distributed in each area, and the intelligent transfer vehicles in the area to be dispatched enter the transfer mode:

If a man-driven transfer mode is selected, the intelligent transfer vehicle is operated by the driver, and the driver can choose to plan the travel route based on experience or through the path planning module in the vehicle-mounted unit.

If a human-vehicle hybrid transfer mode is selected, the intelligent transfer vehicle will autonomously travel according to human instructions through an automatic driving module in the vehicle-mounted unit.

If the unmanned autonomously transfer mode is selected, the intelligent transfer vehicle will plan the route and drive automatically according to the area and time set in advance through the path planning module and the automatic driving module. In this mode, to ensure safety of the driving, the operator of the dispatch command center can terminate the current operation at any time by controlling the emergency stop device, and can also switch to the man-driven transfer mode or the intervention mode.

After the transfer mode of the intelligent transfer vehicle is set, the intelligent transfer vehicle enters the start-up mode. The current operation of the components of the intelligent transfer vehicle is checked by the fault diagnosis module. If the components are operating normally, the wheels at the bottom of the body platform are extended and the intelligent transfer vehicle starts. At this time, the voice device in the alarm and emergency processing module and the alarm light device on the top of the cockpit issue voice and light warnings to alert that the vehicle is starting. If any component of the intelligent transfer vehicle malfunctions, the alarm mode will be activated and the alarm device sends an alarm message to the dispatch center through the communication module.

After the vehicle starts, the voice and light warnings are stopped. During the operation of the intelligent transfer vehicle, if the current task is changed or any unexpected event occurs, such as unplanned change of the transfer area, if the current transfer mode is a man-driven mode or a human-vehicle hybrid transfer mode, the driver in the cockpit will directly perform the changed task; if the current transfer mode is an unmanned autonomous transfer mode, the staff at the dispatch center will switch to intervention mode to intervene and interrupt the current task by human-vehicle hybrid or man-driving.

During the operation of the intelligent transfer vehicle, if an abnormality or unexpected situation occurs, such as a vehicle collision, etc. (the collision is detected by multiple collision sensors installed on the body platform), the alarm mode will be activated. And the intelligent transfer vehicle will stop the current operation and send an alert to the dispatch center immediately for follow-up processing.

When the intelligent transfer vehicle reaches its destination, the wheels at the bottom of the vehicle body platform are retracted, and the parking mode is activated again.

An example is as follows. If there is a need to transfer a number of shared bicycles from area A to area B at time C. First, the parking mode of intelligent transfer vehicle is switched to transfer mode.

If a human-vehicle hybrid or man-driven transfer mode is used, it can be completed by the operator or driver on time.

If an unmanned autonomous transfer method is selected, the dispatch center can send the set target area B and start time C to a certain number of intelligent transfer vehicles in area A in advance according to the transfer needs and the number of shared bicycles currently carried by each intelligent transfer vehicle. These intelligent transfer vehicles will travel autonomously at set times C.

Then the start-up mode of the intelligent transfer vehicle is activated, and the fault diagnosis module checks the transfer vehicle. If no fault occurs, the wheeled device is extended and the vehicle starts. If an unexpected situation occurs during the driving process, for example because of a change in demand, a transfer to the E area is suddenly required. The dispatch center will adopt the intervention mode, which switches to the human-vehicle hybrid or man-driven transfer mode to direct these intelligent transfer vehicles to complete the follow-up actions through issuing commands or re-planning route.

### Embodiment 2

In this embodiment, the wheeled device is non-retractable. In order to facilitate park/take shared bicycles, a landing board is provided at the end of the vehicle body platform. When the transfer vehicle is parked, the transfer vehicle is used as a parking rack. One end of the steel landing board at the end of the vehicle body platform protrudes obliquely downward and contacts the ground to form a passage between the vehicle body platform and the ground. The user can pick and take the bicycle on the platform through the steel landing board; before the intelligent transfer vehicle starts, the landing board is retracted and leaves the ground, so that the vehicle can run normally.

The landing board can be implemented as follows: the bottom of the landing board is hinged to the vehicle body platform; when the vehicle body platform is used to transfer shared bicycles, the landing board is limited to a vertical position by a limiting mechanism and does not contact the ground; when the vehicle body platform is used to park the shared bicycles, the limit of the limit mechanism is released, and the landing board is rotated outward around its hinge with the vehicle body platform until it contacts the ground.

In summary, the above are only preferred embodiments of the present invention, and are not intended to limit the protection scope of the present invention. Any modification, equivalent replacement, or improvement made within the spirit and principle of the present invention shall be included in the protection scope of the present invention.

1. An intelligent transfer vehicle for shared bicycle, comprising:
a cockpit, a vehicle body platform, shared bicycle parking racks, wheeled device, power source unit, and a vehicle-mounted unit,
wherein the vehicle-mounted unit is provided in the cockpit and the intelligent transfer vehicle is provided with the functions of man-driven and unmanned autonomous travel through the vehicle-mounted unit;
wherein the wheeled device is located at the bottom of the vehicle body platform;
wherein two or more shared bicycle parking racks are provided on the vehicle body platform;
wherein the vehicle body platform serves as a parking platform when the intelligent transfer vehicle is parked, and users can park or take a shared bicycle thereon; and during traveling of the intelligent transfer vehicle, the vehicle body platform serves as a transfer platform for the transfer of shared bicycles;
wherein power source unit provides energy and power for the intelligent transfer vehicle.

2. The intelligent transfer vehicle of claim 1, wherein the wheeled device includes a plurality of retractable wheels arranged at the bottom of the vehicle body platform, wherein when the intelligent transfer vehicle is parked, the wheels are retracted into the vehicle body platform so that the vehicle body platform lies on the ground, and wherein before the intelligent transfer vehicle starts, the wheels are extended to contact the ground to enable the intelligent transfer vehicle to travel.

3. The intelligent transfer vehicle of claim 1, wherein a landing board is provided at the end of the vehicle body platform, wherein when the transfer vehicle is parked, one end of the landing board at the end of the vehicle body platform protrudes obliquely downward and contacts the ground to form a passage between the vehicle body platform and the ground, and before the intelligent transfer vehicle starts, the landing board is retracted to leave the ground.

4. The intelligent transfer vehicle of claim 1, wherein the intelligent transfer vehicle for shared bicycle has three transfer modes: a man-driven transfer mode, an unmanned autonomous transfer mode, and a human-vehicle hybrid transfer mode, wherein:
in the man-driven transfer mode, the intelligent transfer vehicle is manually operated by the driver according to dispatch task requirements;
in the unmanned autonomously transfer mode, the intelligent transfer vehicle starts at a preset start time and travels autonomously according to a planned route, and completes the planned route by the vehicle-mounted unit according to a preset destination;
in the human-vehicle hybrid transfer mode, the intelligent transfer vehicle travels autonomously according to a control instruction issued by a dispatch center received by the vehicle-mounted unit.

5. The intelligent transfer vehicle of claim 4, wherein the vehicle-mounted unit includes a data storage module, an instruction understanding module, a path planning module, and an automatic driving module, and wherein the path planning module includes a GIS (Geographic Information System) module, a navigation and positioning module, and an autonomous planning and decision-making module, and wherein
the data storage module is connected with the other modules in the vehicle-mounted unit (6) for data interaction and stores the received data information;
the instruction understanding module and the communication module are connected and interacted to complete the analysis of the received instructions from the dispatch center, and then the parsed information is sent to the path planning module according to the pre-stored analysis instruction set;
in the unmanned autonomous mode, the path planning of the intelligent transfer vehicle is coordinated by the GIS module, navigation and positioning module and the autonomous planning decision module in the path planning module, and a planned path is sent to the autonomous driving module, which generates an optimal path based on which the intelligent transfer vehicle travels autonomously.

6. The intelligent transfer vehicle of claim 5, wherein the vehicle-mounted unit includes an alarm and emergency processing module comprising a voice device, an alarm device and an emergency stop device, wherein the voice device is configured to send voice and light warnings in conjunction with the alarm light device on the top of the cockpit when the intelligent transfer vehicle starts and stops, the alarm device is configured to send an alarm to the dispatch center through the communication module when an unexpected situation occurs in the transfer vehicle, and the emergency stop device is configured to suspend the current operation of the transfer vehicle.

7. The intelligent transfer vehicle of claim 6, wherein the vehicle-mounted unit includes a fault diagnosis module configured to obtain running status data of the intelligent transfer vehicle in real-time, and diagnose and predict possible faults.

8. The intelligent transfer vehicle of claim 5, wherein each shared bicycle parking rack is provided with a sensor for detecting whether there is a shared bicycle parked, wherein when a shared bicycle is parked on a parking rack, the sensor on the parking rack senses it and sends a bicycle storage signal to the data storage module, which records the number of shared bicycles carried by the transfer vehicle in real-time according to the bicycle storage signal, and then transmits the recorded number of shared bicycles to the dispatch center through the communication module.

9. The intelligent transfer vehicle of claim 6, wherein during the operation of the intelligent transfer vehicle, if the current task is changed or abnormal, such as unplanned change of the transfer area, if the current transfer mode is a man-driven mode or a human-vehicle hybrid transfer mode, the driver in the cockpit will directly perform the changed task; if the current transfer mode is an unmanned autonomous transfer mode, the staff at the dispatch center will switch to intervention mode to intervene and interrupt the current task by human-vehicle hybrid or man-driven transfer mode.

10. The intelligent transfer vehicle of claim 5, further comprising sensors for sensing road information around the position of the intelligent transfer vehicle.
